(19) United States
(12) Patent Application Publication
(10) Pub. No.: US 2014/0288951 A1
(43) Pub. Date: Sep. 25, 2014

(54) INTERNET SYSTEM FOR CONNECTING HEALTHCARE PROVIDERS AND PATIENTS

(71) Applicant: Michael A. Zielinski, Appleton, WI (US)

(72) Inventor: Michael A. Zielinski, Appleton, WI (US)

(21) Appl. No.: 14/221,270

(22) Filed: Mar. 20, 2014

Related U.S. Application Data
(60) Provisional application No. 61/804,497, filed on Mar. 22, 2013.

(51) Int. Cl. G06Q 50/22; G06Q 10/10

(52) U.S. Cl. CPC G06Q 50/22; G06Q 10/10
USPC 705/2

(57) ABSTRACT

An example Internet-based system involves a database and search capabilities for connecting patients with healthcare providers, and further enables such providers to reach patients with whom they may not otherwise come into contact. A patient may access the healthcare provider information through a search conducted using a search engine. Alternatively, a patient may access the company website's predetermined web page that provides search capabilities on its database. A patient may research a healthcare provider based on criteria specified by the patient. Information provided to the patient may be in the form of a report or profile, including healthcare provider verified information, information verified by an independent third party, and patient provided information. The patient provided information may be in the form of endorsements from former patients that identify skill areas that are areas of strength for the healthcare providers.

This application claims the benefit of U.S. Provisional Patent Application No. 61/804,497, to Michael Zielinski, filed Mar. 22, 2013, and entitled “INTERNET SYSTEM FOR CONNECTING HEALTHCARE PROVIDERS AND PATIENTS,” which is incorporated herein by reference in its entirety.

### TECHNICAL FIELD

This disclosure relates to techniques and systems for connecting patients with healthcare providers and, more particularly, providing Internet-based access to compiled reports.

### BACKGROUND

People may wish to have access to as much information as possible prior to making decisions regarding purchases or selection of service providers. The Internet has become a significant source of information to consumers in general. Indeed, consumers rely heavily on the Internet for obtaining information and data related to researching a myriad of subjects. Many Internet websites have developed various models attempting to help the general public to find products and services for which the public may be seeking. A popular model has been in the form of websites that allow for the general public to provide reviews and ratings of various subject matter such as hotels, restaurants, and general contractors.

### SUMMARY

Example techniques and systems described herein are related to an Internet-based system that involves a database and search capabilities for connecting patients with healthcare providers, e.g., physicians, dentists, chiropractors, and the organizations that employ them, and further enables such providers to reach patients with whom they may not otherwise come into contact. A patient may access the healthcare provider information through a search conducted using a search engine, such as Google, Yahoo, etc. Alternatively, a patient may access the company website's predetermined web page that provides search capabilities on its database. A patient may research a healthcare provider based on criteria specified by the patient. Information provided to the patient may be in the form of a report or profile, including healthcare provider verified information, information verified by an independent third party, and patient provided information. The patient provided information is in the form of endorsements from former patients that only allow positive feedback and may identify one or more skills that are areas of strength for the respective healthcare providers, but do not allow ratings of the healthcare providers. The verified information and patient provided information is presented on the website to enable patients to differentiate among healthcare providers and thereby select the provider that best meets their individual needs.

Some examples of the present disclosure allow potential patients to perform searches for healthcare providers based on geographic area, specialty, and/or other criteria, in which the company maintaining and/or managing the website (herein after, the “company”) compiles and produces a results list of providers meeting such criteria. From this list, a potential patient may access a detailed report in the form of a “profile” on a particular provider listed in the search results. In an example, a potential patient may more efficiently identify a healthcare provider of interest from the results list, by refining or sorting the list based on characteristics of the providers that may be more important to them including gender, endorsed skills that have been identified by former patients as areas of strength for the provider, the provider's years of experience, and insurance plans the provider accepts. Not only may a potential patient research providers this way, but in another example, they may also research healthcare organizations in a similar fashion.

In one example, the disclosure describes a method including receiving, by a first computing device associated with a service for connecting healthcare providers with potential patients, a request for information regarding healthcare providers, wherein the first computing device comprises at least one processor, accessing, by the first computing device, healthcare provider-verified information about a plurality of healthcare providers, wherein the healthcare provider-verified information is received from the healthcare providers, compiling, by the at least one processor, patient provided information related to one or more of the plurality of healthcare providers, wherein the patient provided information comprises patient endorsements from one or more past or current patients of the healthcare providers, and wherein the patient endorsements were received via an online patient endorsement survey configured to receive a positive indication of strength for each of a plurality of skill areas associated with each of the healthcare providers, and wherein the online patient endorsement survey is hosted by a website associated with the service for connecting healthcare providers with the potential patients, compiling information regarding the healthcare providers verified by an independent third-party source, generating, by the at least one processor and based on the healthcare provider-verified information, the patient provided information, and the information regarding the health care providers verified by the independent third-party source, a healthcare provider report for at least one of the plurality of healthcare providers, wherein the healthcare provider report for the at least one healthcare provider is configured to include one or more endorsements of the at least one healthcare provider, and wherein the one or more endorsements relate to respective skill areas of the at least one health care provider, and transmitting, by the at least one processor and via a network, the healthcare provider report to a second computing device.

In another example, the disclosure describes a system for connecting healthcare providers with potential patients, the system including at least one processor configured to receive a request for information regarding a healthcare provider, access healthcare provider-verified information about the healthcare provider, wherein the healthcare provider-verified information is received from the healthcare provider, compile patient-provided information related to the healthcare provider, wherein the patient provided information comprises patient endorsements from one or more past or current patients of the healthcare provider, and wherein the patient endorsements were received via an online patient endorsement survey configured to receive a positive indication of strength for each of a plurality of skill areas associated with the healthcare provider, and wherein the online patient endorsement survey is hosted by a website associated with a service for connecting healthcare providers with the potential patients and completed by the one or more past or current patients of the healthcare provider, compile healthcare provider information regarding the healthcare provider verified by an independent third-party source, generate, based on the healthcare provider-verified information, the patient-provided information, and the information verified by the independent third-party source, a healthcare provider report for the healthcare provider, wherein the healthcare provider report for the healthcare provider is configured to include one or more endorsements of the healthcare provider, and transmit, via a network, the healthcare provider report to a patient computing device.

In another example, the disclosure describes a computer-readable storage medium comprising instructions that, when executed by one or more processors of a first computing device, cause the one or more processors to receive, by the first computing device associated with a service for connecting healthcare providers with potential patients, a request for information regarding healthcare providers, wherein the first computing device comprises at least one processor, access, by the first computing device, healthcare provider-verified information about a plurality of healthcare providers, wherein the healthcare provider-verified information is received from the healthcare providers, compile patient provided information related to one or more of the plurality of healthcare providers, wherein the patient provided information comprises patient endorsements from one or more past or current patients of the healthcare providers, and wherein the patient endorsements were received via an online patient endorsement survey configured to receive a positive indication of strength for each of a plurality of skill areas associated with each of the healthcare providers, and wherein the online patient endorsement survey is hosted by a website associated with the service for connecting healthcare providers with the potential patients, compile information regarding the healthcare providers verified by an independent third-party source, generate, based on the healthcare provider-verified information, the patient provided information, and the information regarding the health care providers verified by the independent third-party source, a healthcare provider report for at least one of the plurality of healthcare providers, wherein the healthcare provider report for the at least one healthcare provider is configured to include one or more endorsements of the at least one healthcare provider, and wherein the one or more endorsements relate to respective skill areas of the at least one health care provider, and transmit, via a network, the healthcare provider report to a second computing device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1a provides an illustration of an example network environment enabling patients to research healthcare providers and healthcare organizations through a search page on the company website.

FIG. 1b is a representation of an example search page on the company website that enables a user to research doctors and/or healthcare organizations.

FIG. 2a provides a flow chart diagram depicting an example process a patient follows when researching healthcare providers or healthcare organizations on the company website.

FIG. 2b provides a schematic of an example healthcare provider search results on the company website.

FIG. 2c is a representation of an example healthcare provider search results page on the company website.

FIG. 2d provides a flow chart diagram depicting an example process a patient follows when refining and/or sorting the healthcare provider search results.

FIG. 2e is a schematic of an example healthcare provider search results on the company website after a user has refined and sorted the results.

FIG. 2f is an example representation of the healthcare provider search results page on the company website after a user has refined and sorted the results.

FIG. 3a is a schematic of an example web page displaying the healthcare provider report or profile on the company website.

FIG. 3b is a representation of an example healthcare provider report or profile page on the company website.

FIG. 4 provides a flow chart diagram depicting an example process of how an Internet user searches for healthcare provider information on an Internet search engine such as Google or Yahoo and is then able to arrive at the company website to view a healthcare provider's report/profile or a list of search results that satisfy the search criteria utilized on the Internet search engine.

FIG. 5a provides a schematic of an example patient endorsement survey on the company website.

FIG. 5b is a representation of an example patient endorsement survey page on the company website.

FIG. 5c provides a flow chart diagram depicting example paths through which a patient may reach a patient endorsement survey of a particular healthcare provider on the company website.

FIG. 5d is a representation of an example healthcare provider's report or profile on the company website where the healthcare provider's patient endorsement information is displayed.

FIG. 6 provides a flow chart diagram depicting an example technique for compiling a healthcare provider's report or profile and storing the report or profile in the company's database.

FIG. 7 provides a diagram depicting an example computer system for implementing at least a portion of the example techniques described herein.

### DETAILED DESCRIPTION

It is commonly known that a robust environment for feedback exists online for many of these industries, and that has changed them for the better. However, to this date, there is no such authoritative collection of feedback from the general public related to healthcare providers.

Over the years, various Internet websites have attempted to connect healthcare providers and patients. However, all suffer from the same problem which has prevented them from being successful in receiving enough feedback from former patients to provide enough information to help connect the healthcare providers and potential patients. The problem preventing these sites from receiving enough feedback from former patients is that all of these sites allow their users the ability to provide ratings of the providers. This poses a problem for several reasons. First, allowing provider ratings creates the potential for users to provide negative feedback about the providers. This leads to healthcare providers and the organizations that employ them to hold a negative opinion of the websites allowing the ratings, as they don't believe a typical patient has enough medical knowledge to provide a negative rating about their experience. This then limits the number of healthcare providers and healthcare organizations that are willing to partner with websites attempting to connect patients and providers, thus preventing collaboration in order to facilitate the provision of feedback online. The second reason allowing ratings of providers may limit the amount of feedback these sites receive is that former patients have reservations about posting an online rating or review. Many times these reservations are due to fears about being black-listed by their providers that may be able to identify their reviews on these sites that they do not like. Other times, former patients fear posting ratings and reviews due to potential legal ramifications associated with doing so. Several websites allowing users to post reviews and ratings have had their users sued by the party being rated. Therefore, it is not surprising that one of the foremost authorities in researching internet trends, the PEW Research Center, has found only 4% of Americans have reviewed healthcare providers online. This is a start contrast in comparison to other research which has indicated up to 47% of Americans post online ratings and reviews in other industries.

Although many websites or services have been so unsuccessful for so long in receiving former patient feedback regarding healthcare providers, no one has considered allowing patient feedback that does not permit ratings or reviews of providers. However, the disclosure presented here is an Internet-based system and method that connects patients with healthcare providers allowing patient-provided feedback, but only in the form of endorsements that allow only positive feedback, without permitting ratings of providers. In other words, the endorsements do not include negative feedback which typically occurs in a ratings-based system.

There is a significant difference in patient feedback in the form of ratings as compared to patient feedback in the form of endorsements that only allow positive feedback. According to most definitions in dictionaries and other sources, the definition of a rating is “a classification of ranking of someone or something based on a comparative assessment of their quality, standard, or performance” whereas the definition of an endorsement is “an act of giving one's public approval or support to someone or something.” The main difference is that negative feedback can be given with a rating whereas negative feedback cannot be given with an endorsement. In other words, providing an endorsement of a healthcare provider indicates positive approval of the healthcare provider. Therefore, not allowing ratings, but instead allowing patient provided feedback in the form of endorsements such as endorsements that identify specific skills that are areas of strength for a provider, is the key for a system to ultimately succeed in effectively connecting patients and healthcare providers.

There are many sources of both public and private information about healthcare providers that makes it easy to display this basic data and create websites that attempt to connect patients and healthcare providers. However, it is the website that is able to provide the most patient feedback and feedback that contains the most useful information that will ultimately be successful in accomplishing the goal of connecting providers and patients. That is why the disclosure presented here, by allowing patient provided feedback that only permits website users to provide positive feedback in the form of endorsements will be received so much better by the healthcare community, including the healthcare providers themselves and the organizations that employ them. Not only will the healthcare community be more open to partnering with such a website in helping to establish online patient feedback, but patients will also be more open to providing their feedback on such a site as they will not fear any potential for legal action against them nor fear in any way that providers will see their feedback on such a site. Then by allowing, within the endorsements, the ability for former patients to identify specific skills as areas of strength for a provider, the substance of the patient feedback will be greater and provide for more usable feedback. In other words, identification of specific skills as areas of strength for the healthcare provider provides approval of these identified skills without providing any negative feedback regarding the healthcare provider. It is this combination that will allow for the present disclosure to provide an Internet-based system and method that is ultimately successful in connecting patients and healthcare providers.

Online reports that are comprised of detailed healthcare provider information with verified information sections, including healthcare provider verified and/or independent third-party-verified portions, and information from former patients that have seen the healthcare providers in the form of endorsements that only allow positive feedback identifying skills that are areas of strength for the healthcare provider, without allowing ratings and/or reviews of the providers. This system allows patients to differentiate between healthcare providers when they are attempting to find a healthcare provider that fits their needs.

In some examples of the present disclosure, a system allows potential patients to perform searches for healthcare providers based on geographic area, specialty, and/or other criteria, in which the company maintaining and/or managing the website (herein after, the “company”) compiles and produces a results list of providers meeting such criteria. From this list, a potential patient may access a detailed report in the form of a “profile” on a particular provider listed in the search results. In an example, a potential patient may more efficiently identify a healthcare provider of interest from the results list, by refining or sorting the list based on characteristics of the providers that may be more important to them including gender, endorsed skills that have been identified by former patients as areas of strength for the provider, the provider's years of experience, and insurance plans the provider accepts. Not only may a potential patient research providers this way, but in another example, they may also research healthcare organizations in a similar fashion.

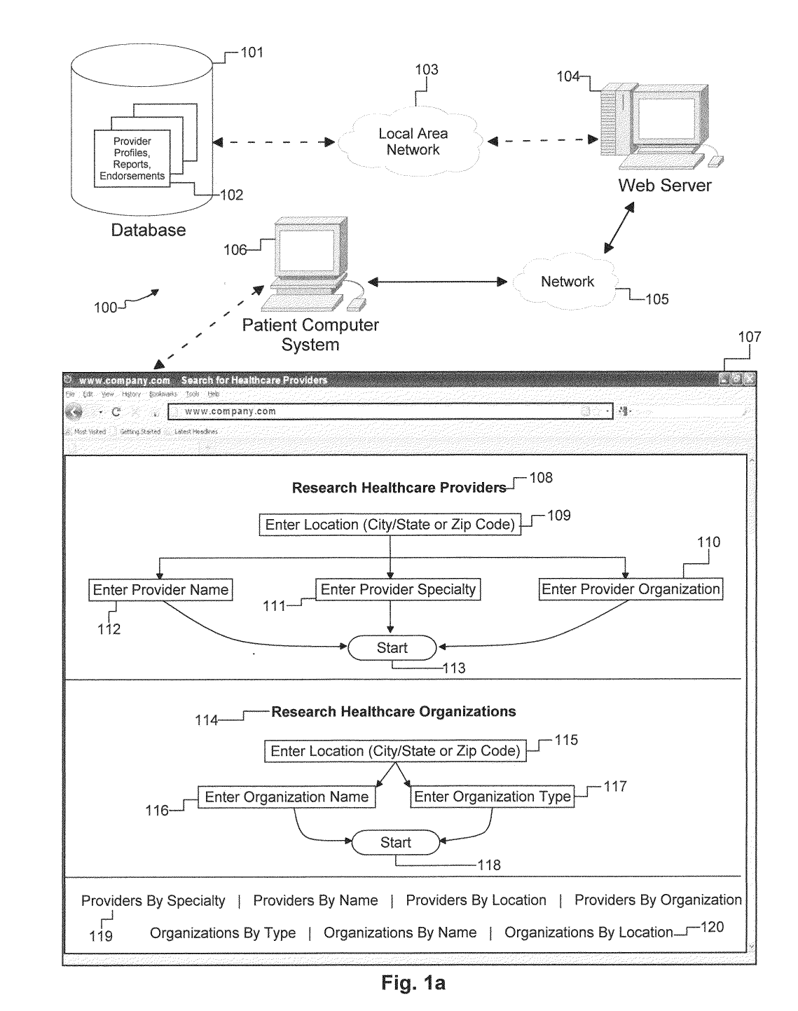

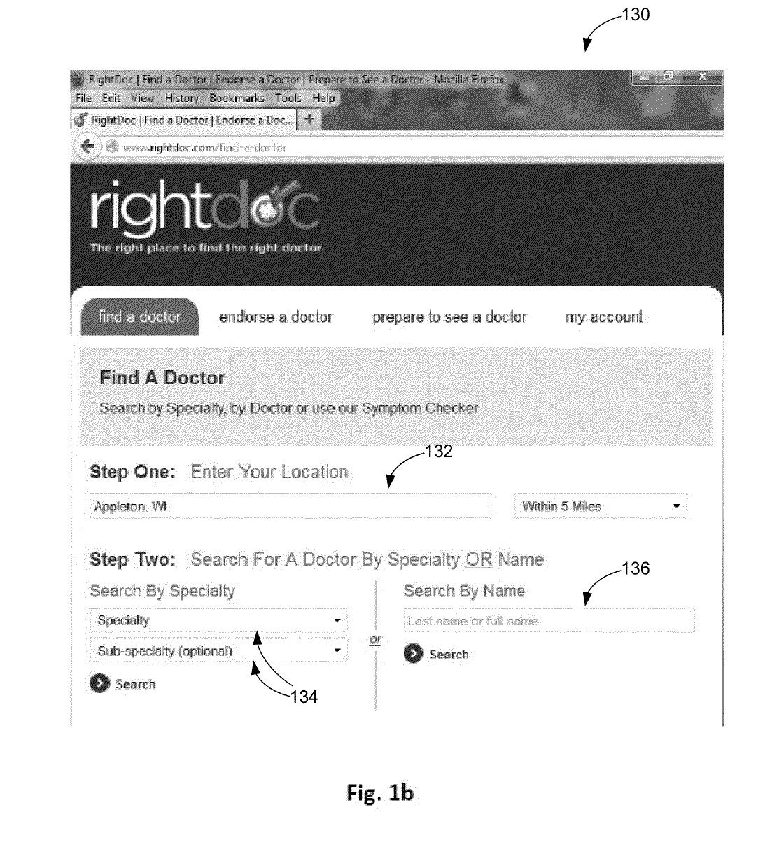

FIG. 1a provides a representation of an example network environment enabling potential patients to access a system in order to research healthcare providers or healthcare organizations on a company website by obtaining verified information including, but not limited to, patient endorsements for the healthcare providers and organizations with the absence of ratings and reviews for these providers and organizations. A “potential patient” or “patient” is anyone seeking healthcare provider or healthcare organization information and may be also called a consumer or user.

The network environment 100 demonstrates a database 101 containing healthcare provider and healthcare organization information and data 102 accessible via a local area network 103 through a web server 104 by potential patients using a network 105 and a patient computer system 106. The database 101 containing healthcare provider and organization data 102, the local area network 103, and the web server 104 are maintained by the company managing the website (herein after, the “company”). Although only one of each of the elements in the network environment is display, there may be multiple numbers of each element used within the environment, including but not limited to, multiple potential patients using multiple patient computer systems 106 using multiple networks 105 accessing multiple web servers 104 which may access multiple databases 101 of healthcare provider and organization information and data 102 through a local area network 103.

On the company website, potential patients may gain access to healthcare provider and healthcare organization information 102 through a predetermined web search page 107 allowing the users to search for healthcare providers and healthcare organizations that meet search criteria.

In using the research healthcare provider's tool 108, the user enters a provider's location 109 and is then prompted to choose to search by either the healthcare organization to which a healthcare provider belongs 110, the healthcare provider's specialty 111, or the healthcare provider's name 112. When entering the provider's location 109, the user may enter a city and state or may enter a zip code. When entering a provider's organization 110, this may be entered by the user or selected by the user from a list of organizations within the location specified. When entering a provider's specialty 111, this may be entered by the user or may be selected by the user from a list of specialties and sub-specialties. When entering a provider's name 112, the name of a particular provider of interest is inputted by the user. The user is then prompted to start their search by clicking a search link or button 113.

In using the research healthcare organizations tool 114, the user enters an organization's location 115 and is then prompted to choose to search by either the healthcare organization's name 116 or by the type of organization 117 they are seeking to find. When entering the organization's location 115, the user may enter a city and state or may enter a zip code. When entering a healthcare organization's name 116, this may be entered by the user or selected by the user from a list of organizations within the location specified. When entering an organization's type 117, this may be entered by the user or selected by the user from a list of organization types. The user is then prompted to start their search by clicking a search link or button 118.

In another example, the user may search for healthcare providers accessing alphabetized lists of provider specialties, provider names, provider locations, or provider organizations by clicking the appropriate links 119 at the bottom of the web search page 107 depending on how the user may want to search for a provider.

In yet another example, the user may search for healthcare organizations accessing alphabetized lists of organization types, organization names, or organization locations by clicking the appropriate links 120 at the bottom of the web page depending on how the user may want to search for an organization.

FIG. 1b is a representation of the search web page 130 on the company website providing an example of a website user researching to find a doctor using the same methods as described in FIG. 1a. Although this search page does not demonstrate so, the search web page 130 would also provide, to the user, the ability to research healthcare organizations such as was described in FIG. 1a. Location search criteria 132 allows for user selection of the location for which the user desires to look for a healthcare provider. Specialty search criteria 134 provides one or more fields (e.g., text input fields and/or drop-down menus) in which the user can select a specialty for which to refine possible healthcare providers. Specialty and sub-specialties may be included. Name search criteria 136 in an input field for which the user can enter a name of a healthcare provider of interest to the user. Fewer or greater search criteria may be provided in search web page 130 in other examples.

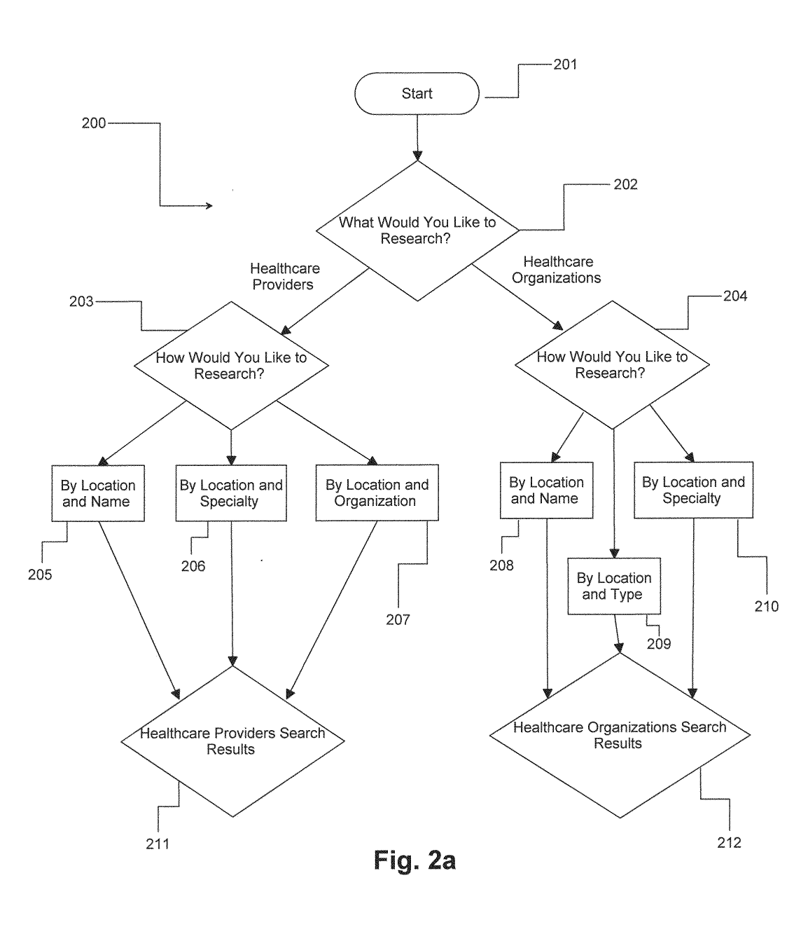

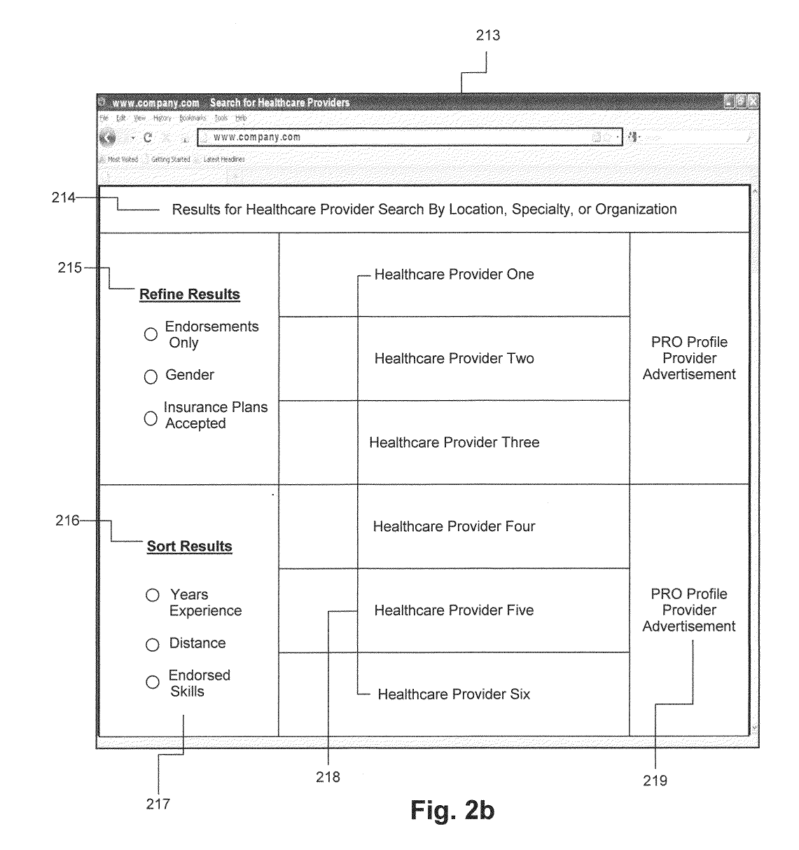

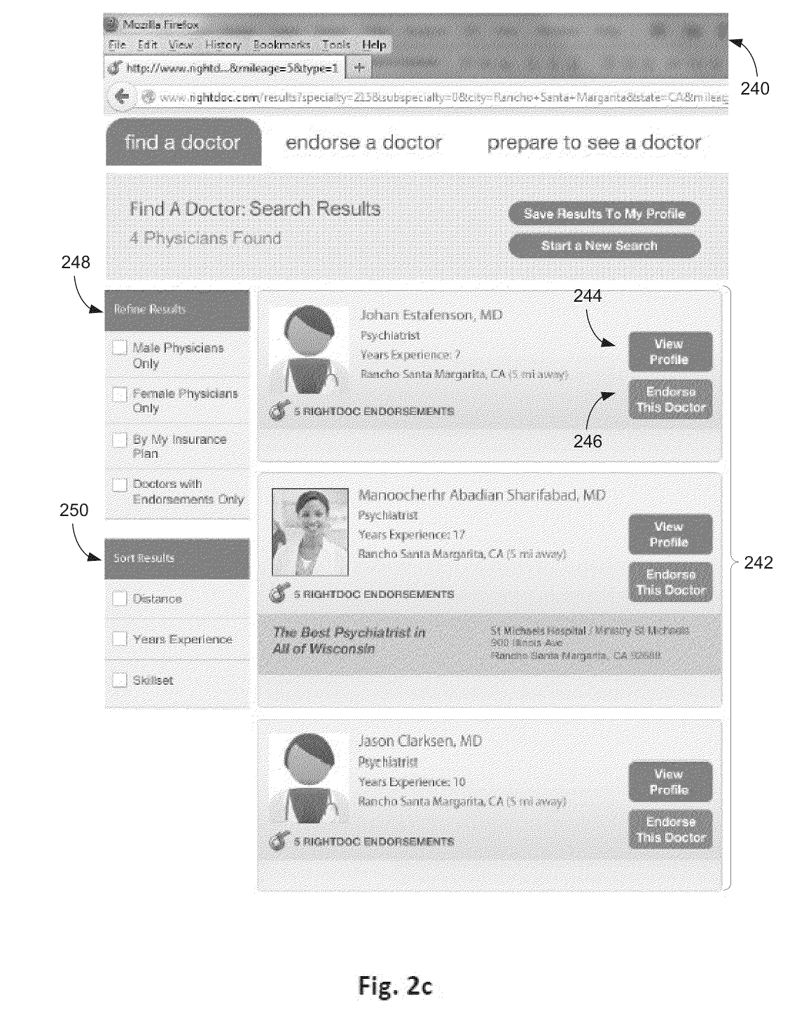

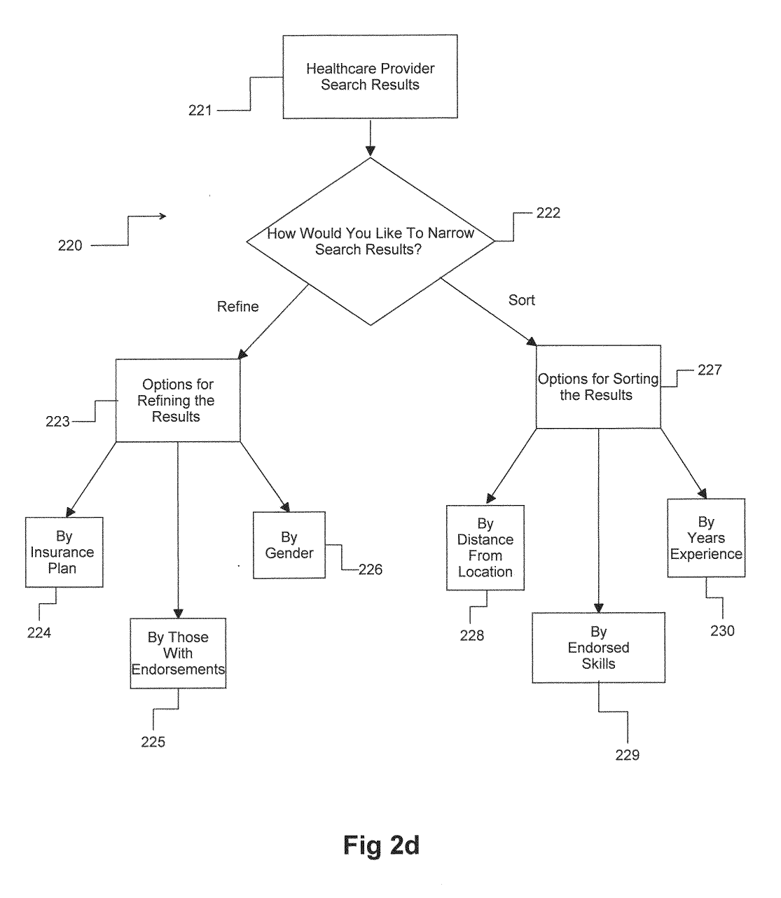

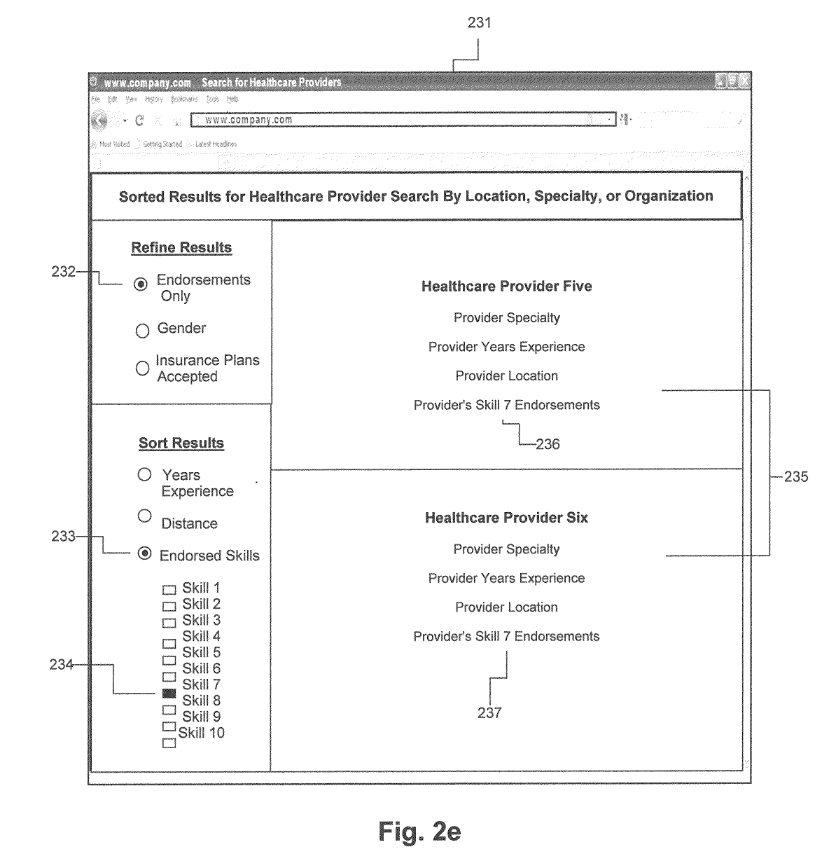

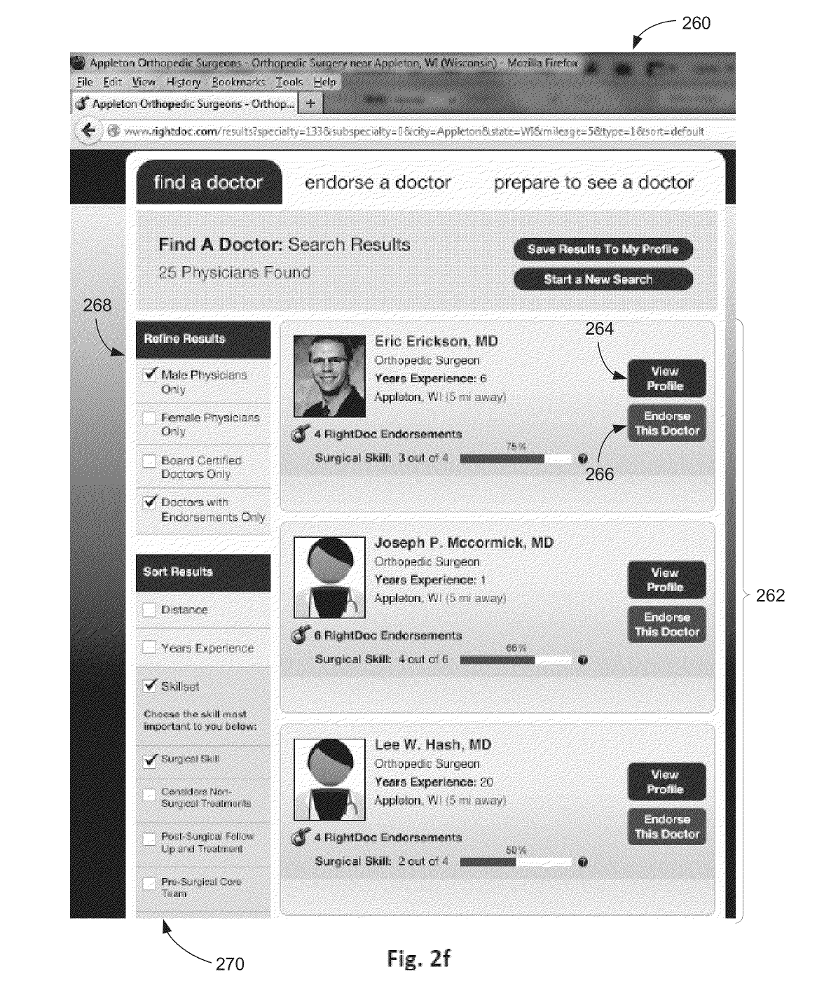

FIG. 2a provides a flow chart diagram depicting the process a patient follows when researching healthcare providers or healthcare organizations 200 on the company website such as in FIG. 1a. The start 201 represents the user has selected to research healthcare provider or healthcare organization information 102 on the company website. The user is then asked to decide if they would like to more specifically research healthcare providers or healthcare organizations 202.

If the user chooses to research healthcare providers, they are given options of search criteria to use when searching for providers 203 whether it by a combination of location and provider name 205, location and provider specialty 206, or location and a provider's organization 207. After choosing the appropriate method and entering the appropriate search criteria, the company website returns a list of healthcare providers 211 meeting the search criteria.

If the user chooses to research healthcare organizations, they are given options of search criteria to use when searching for organizations 204 whether it by a combination of location and organization name 208, location and organization type 209, or location and an organization specialty 210. After choosing the appropriate method and entering the appropriate search criteria, the company website returns a list of healthcare organizations 212 meeting the search criteria.

FIG. 2b provides a schematic of the healthcare provider search results page 213 on the company website such as those returned at the end of FIG. 2a after the user has entered in their search criteria. The area at the top of the healthcare provider search results web page 213, the number of providers found and the criteria used to provide the search results 214 is listed.

The list of healthcare providers 218 is shown in the middle of the web page as represented by the listings of the six healthcare providers in the Figure. Each individual healthcare provider listing in the search results contains information to help the user identify the provider including, but not limited to, the provider's name, their specialty, their years of experience, their location, and the number of patient endorsements they have. Within the listing is a link the patient may click on to go on to view a more detailed report or profile about the individual healthcare provider and also a link that would lead to a patient endorsement survey, from which a user may provide an endorsement for the individual provider. Another possible example of the healthcare provider listing in the search results is one that would contain an advertisement and more specific practice location information for those providers that have paid a fee to the company to become a “PRO” service member where the healthcare provider has created this advertisement to appear in his or her search result listing. In yet another example, providers that are paying PRO members may receive preferred listing on the default search results list prior to the user using the sort or refine tools mentioned below. A more detailed view of the provider listing in the search results may be viewed in FIG. 2c.

On the left hand side of the search results web page is a refine results tool 215 that allows the user to refine the list of healthcare providers by criteria related and/or unrelated to the original search criteria, including but not limited to, seeing only those providers with endorsements versus those without, viewing providers by a preferred gender, either female or male, and to be able to view only those providers that accept a particular insurance plan. Any one or any combination of the refinement criteria may be used.

On the left hand side of the search results web page is also a sort results tool 216 that allows the user to sort the list of healthcare providers by criteria related and/or unrelated to the original search criteria, including but not limited to, ordering the providers by their years of experience, ordering providers by their distance from the previously identified location, and ordering the providers by the number of patient endorsements they have received regarding a particular endorsed skill 217, as identified by their former patients in patient endorsement surveys. Any one or any combination of the sort criteria may be used.

On the right hand side of the search results web are place holders for advertisements 219 for PRO member and non-member providers and their organizations.

Although FIG. 2b displays a results list for healthcare providers, the search results list would be similar for healthcare organizations if the user chose to research the organizations versus the providers. The search results web page for organizations would be similar in appearance and in function in that the user would be able to refine and sort the organizations in the search results list on various criteria related and/or unrelated to the original search criteria. It would also be similar in that the user would be able to select a link in the listing that would lead to a profile about the individual organization.

In some examples, the system may generate the results list (i.e., list of healthcare providers 218) based on whether or not one or more of the healthcare providers subscribe or are otherwise associated with an enhanced report. For example, one or more healthcare providers may choose to subscribe to an enhanced report that may include items such as additional information about the healthcare provider and/or may provide additional compensation to be associated with an enhanced report. When a healthcare provider is selected, based on the refining criteria and/or sorting criteria at least partially selected by a user, the system may thus generate a results list such that one or more healthcare providers associated with a respective enhanced report are positioned higher (i.e., near the top or more prevalent in the results list) than healthcare providers not associated with an enhanced report.

FIG. 2c is a representation of the search results list web page (e.g., results web page 240) on the company website providing an example of healthcare provider results provided to a user researching healthcare providers, prior to any refinement or any sorting. Results web page 240 may include results from one or more searches requested by a user. Results list 242 includes one or more healthcare providers that satisfy the search criteria selected by the user. View profile input 244 provides, when selected, the profile of the respective healthcare provider. Request to endorse input 246 provides, when selected, an endorsement survey that allows the user to endorse the respective healthcare provider. Refine results tool 248 allows the user to select (e.g., via selectable options) additional search criteria (e.g., refine criteria) to further limit the healthcare providers within results list 242. Sort results tool 250 allows the user to select (e.g., via selectable options) sort criteria that defines the order in which the healthcare providers are presented within results list 242. Although the results search page does not demonstrate so, the search results list for organizations would be similar in appearance and in function to the search results web page for healthcare providers.

FIG. 2d provides a flow chart diagram depicting the process a patient follows when refining and/or sorting the healthcare provider search results list 220. The user may choose to narrow the healthcare provider search results 221 by deciding to either refine or sort the results 222. If the user chooses to utilize the refine results tool 215, the user is given options for refining the results 223. Here the user may select to refine the results by criteria related and/or unrelated to the original search criteria, including but not limited to, by viewing only those providers that accept a particular insurance plan 224, by viewing only those providers with endorsements 225, versus those without endorsements, or by viewing providers by a preferred gender 226, either female or male. Any one or any combination of the refinement criteria may be used.

If the user chooses to utilize the sort results tool 216, the user is given options for sorting the results 227. the user may choose to sort the results by criteria related and/or unrelated to the original search criteria, including but not limited to, ordering providers by their distance from the previously identified location 228, ordering the providers by their years of experience 230, and ordering the providers by the number of patient endorsements they have received regarding a particular patient endorsed skill 229, as identified by their former patients in patient endorsement surveys. Any one or any combination of the sort criteria may be used.

Although the flow diagram in FIG. 2d shows that a user can choose to either refine or sort the results, the user may choose to go back through the process multiple times choosing to either further refine or further sort, or use a combination of sorting and refining, to narrow the search results to their liking.

FIG. 2e is a schematic of an example web page displaying the healthcare provider search results on the company website after a user has both refined and sorted the search results 231. In this particular example of FIG. 2e, the user has refined the results by choosing to view only providers that have had patient endorsements 232. The user has then sorted the results by patient endorsed skills 233, selecting to sort the list of providers by a particular skill, which in this case would be the seventh skill 234. The remaining healthcare providers in the results list, as depicted by providers five and six in the schematic 235, are displayed with information to help the user identify the provider including, but not limited to, the provider's name, their specialty, their years of experience, and their location.

In FIG. 2e, because the user has chosen to sort the provider results by a particular patient endorsed skill, the provider's individual search result listing also then contains a listing of the number of times the provider has been endorsed for that particular skill 236 and 237. This listing can be displayed several ways including, but not limited to, the exact number of times each provider has been endorsed for the particular skill or in a percentage regarding the number of times each provider has been endorsed for the particular skill within an endorsement, versus the total number of endorsements the provider has had.

Although FIG. 2e displays search results for healthcare providers that have been refined and sorted, the refined and sorted search results list for healthcare organizations would be similar if the user chose to research the organizations versus the providers. The refined and sorted search results web page for organizations would be similar in appearance and in function in that the user would be able to refine and sort the organizations in the search results list on various criteria related and/or unrelated to the original search criteria. It would also be similar in that the user would be able to select a link in the listing that would lead to a profile about the individual organization.

FIG. 2f is a representation of a results web page 260 displaying the healthcare provider search results (e.g., results list 262) on the company website after a user has both refined and sorted the search results. The example web page of FIG. 2f may be based on a schematic of the example FIG. 2e. Results web page 260 may include results from one or more searches requested by a user. Results list 262 includes one or more healthcare providers that satisfy the search criteria selected by the user. View profile input 264 provides, when selected, the profile of the respective healthcare provider. Request to endorse input 266 provides, when selected, an endorsement survey that allows the user to endorse the respective healthcare provider. Refine results tool 268 allows the user to select (e.g., via selectable options) additional search criteria (e.g., refine criteria) to further limit the healthcare providers within results list 262. Sort results tool 270 allows the user to select (e.g., via selectable options) sort criteria that defines the order in which the healthcare providers are presented within results list 262. Although this search page of FIG. 2f does not demonstrate so, the search results list for organizations may be similar in appearance and in function to the search results web page for individual healthcare practitioners such as doctors or dentists.

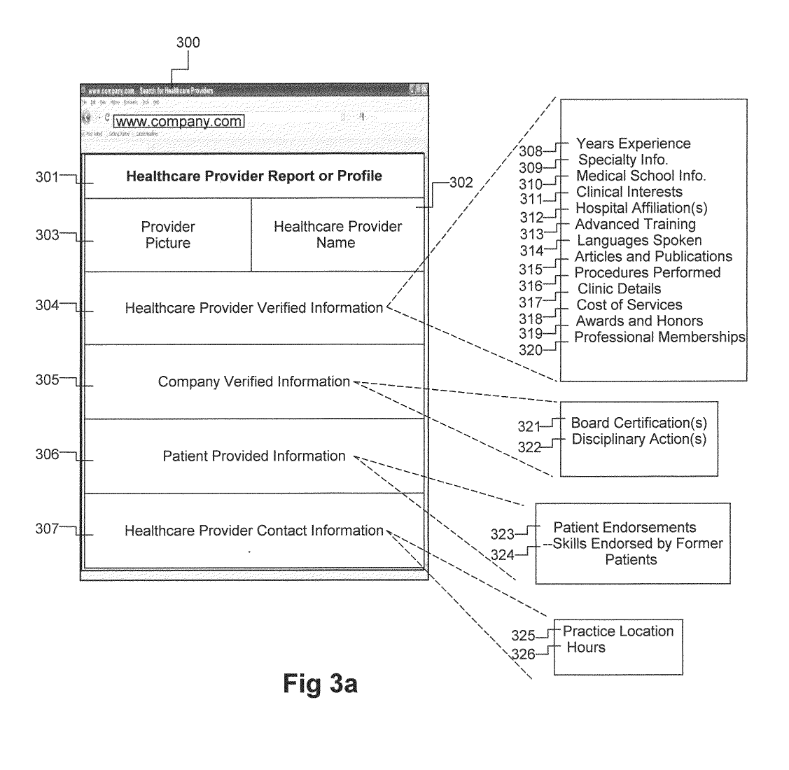

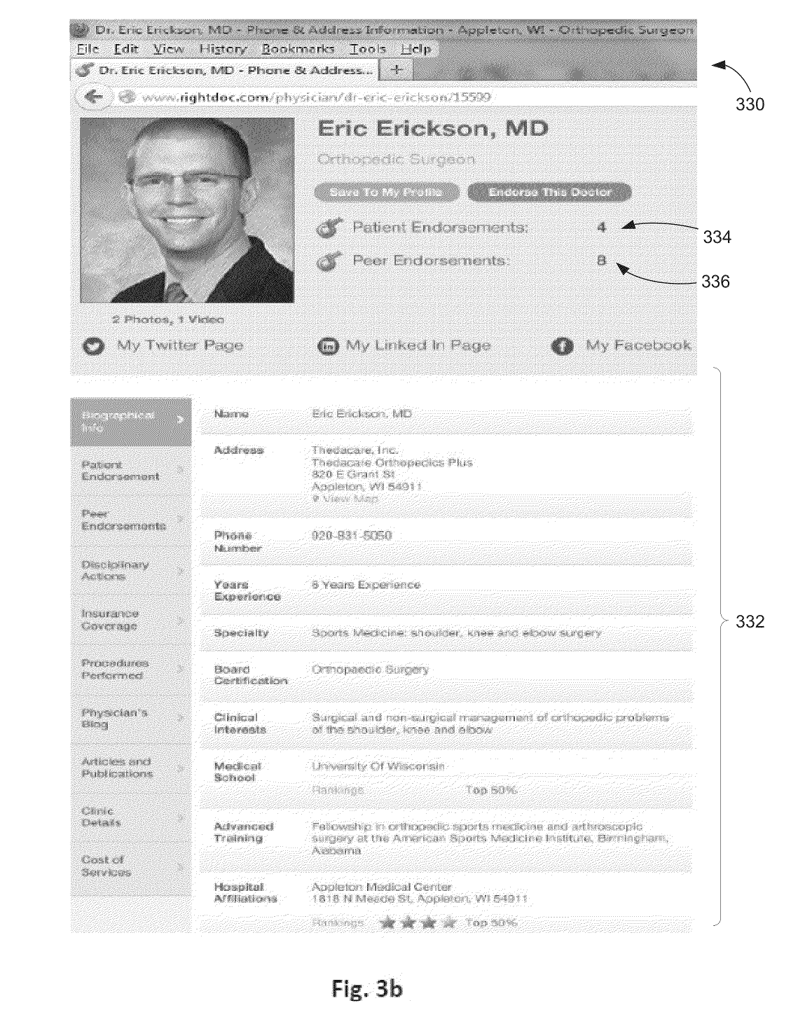

FIG. 3a is a schematic of a web page displaying the healthcare provider profile or report 300 on the company website. Contained within the healthcare provider profile is the healthcare provider profile title 301, the healthcare provider's name 302, the healthcare provider's picture 303, the healthcare provider verified information 304, the company verified information 305, the patient provided information 306, and the healthcare provider contact information 307.

The healthcare provider profile title 301 may or may not contain information including, but not limited to, a tagline identified by the provider himself or herself to identify the profile, wherein the tagline contains one or two sentences describing the provider and/or his or her practice. The healthcare provider's name 302 and the healthcare provider's picture 303 are both displayed near the top of the profile.

In one example, the healthcare provider verified information 304 is displayed in the main body of the profile on the web page and may or may not contain information including, but not limited to, the provider's number of years of experience in their profession 308, the provider's specialty information 309, the provider's medical school information 310, the provider's clinical interests 311, the provider's hospital affiliations 312, the provider's advanced training 313, the provider's languages spoken 314, the provider's articles and publications 315, the provider's procedures performed 316, the provider's clinic details 317, the provider's cost of services 318, the providers awards and honors 319, and the provider's professional memberships 320.

In another example, the company verified information 305 is displayed in the main body of the profile on the web page and may or may not contain information regarding board certification(s) 321 and disciplinary action(s) 322.

In another example, the patient provided information 306 is displayed in the main body of the profile on the web page and may or may not contain patient endorsements 323 from one or more past or current patients of the healthcare provider that have been received from on-line patient endorsement surveys which only allow the patient to provide positive feedback and identify skills that are endorsed by former patients 324 as areas of strength for the healthcare provider, not allowing comparison ratings or reviews, completed on a company website by the one or more past or current patients of the healthcare provider.

In another example, the healthcare provider contact information is displayed in the main body of the profile on the web page and may or may not contain practice location information 325 and/or practice location hours of operation 326.

Although a healthcare provider profile is displayed in FIG. 3a, the profile would be similar for healthcare organizations if the user chose to research the organizations versus the providers. The healthcare organization profile would be similar in appearance and in function in that the user would be able to view information about a healthcare organization including name, picture, organization verified, company verified information, patient provided information, and organization contact information.

FIG. 3b is a representation of the healthcare provider report or profile page (e.g., healthcare provider report 330) on the company website. Healthcare provider report 330 may include information regarding the identified healthcare provider. Provider verified information 332 includes information that may have been verified by the healthcare provider, such as a name, address, years of experience, specialties, education, board certification, advanced training, associated healthcare facilities, or any other information. Patient endorsement field 334 includes the number of patients who have endorsed the identified healthcare provider. Peer endorsement field 336 includes the number of patients who have endorsed the identified healthcare provider. In some examples, the endorsement fields 334 and/or 336 may include additional information, such as one or more commonly identified areas of strength.

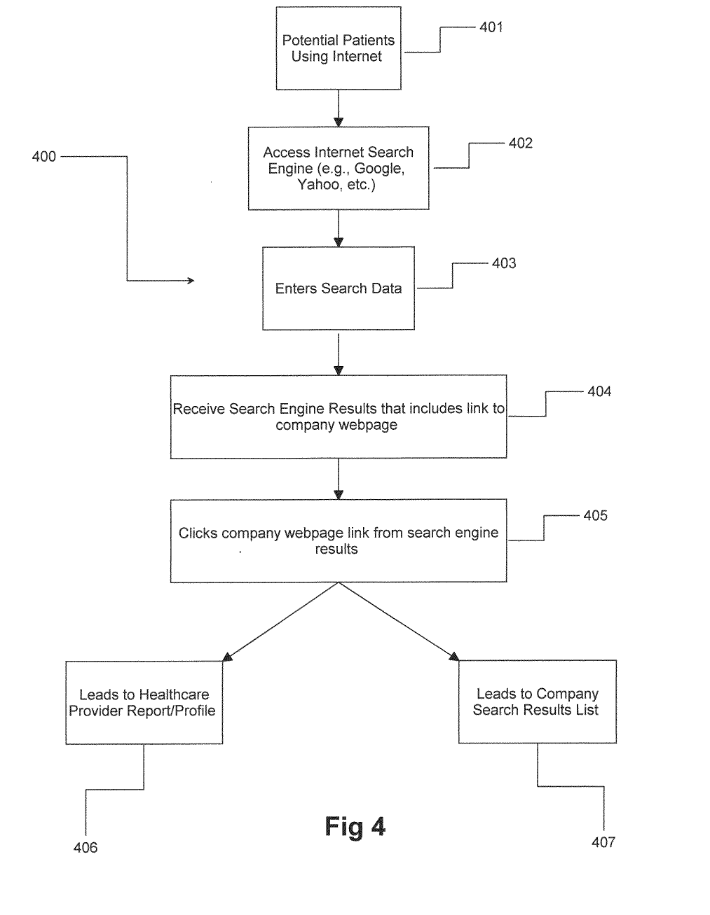

FIG. 4 provides a flow chart diagram depicting the process of how an Internet user searches for healthcare provider information on an Internet search engine such as Google or Yahoo and is then able to arrive at the company website 400 to view a healthcare provider's profile or report or a list of provider search results that satisfy the search criteria utilized on the Internet search engine.

The diagram starts with potential patients using the Internet 401 accessing a general Internet search engine such as Google or Yahoo 402 where the user enters search data 403 searching for information about healthcare providers. The user then receives search engine results from the general Internet search engine which includes a link to a webpage on the company website 404 that the user could click 405 which would then lead to a web page on the company website that either leads to a specific healthcare provider profile 406 on a particular provider or leads to a search results list 407 that meets similar criteria provided by the user when using the general Internet search engine.

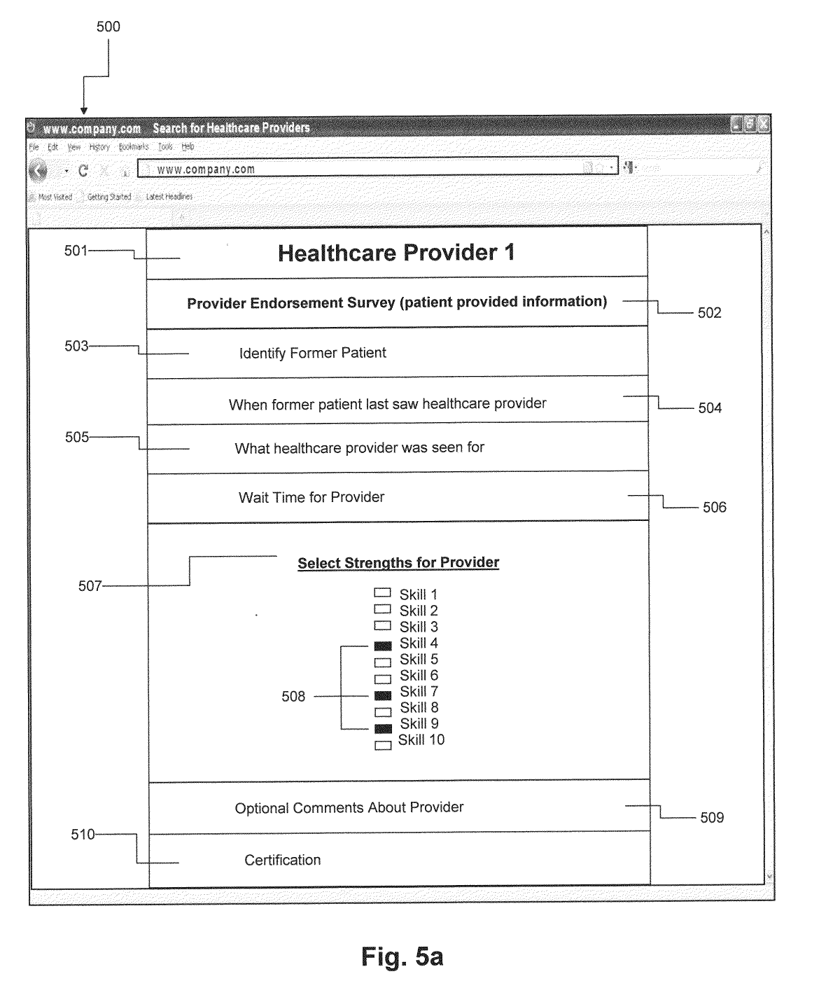

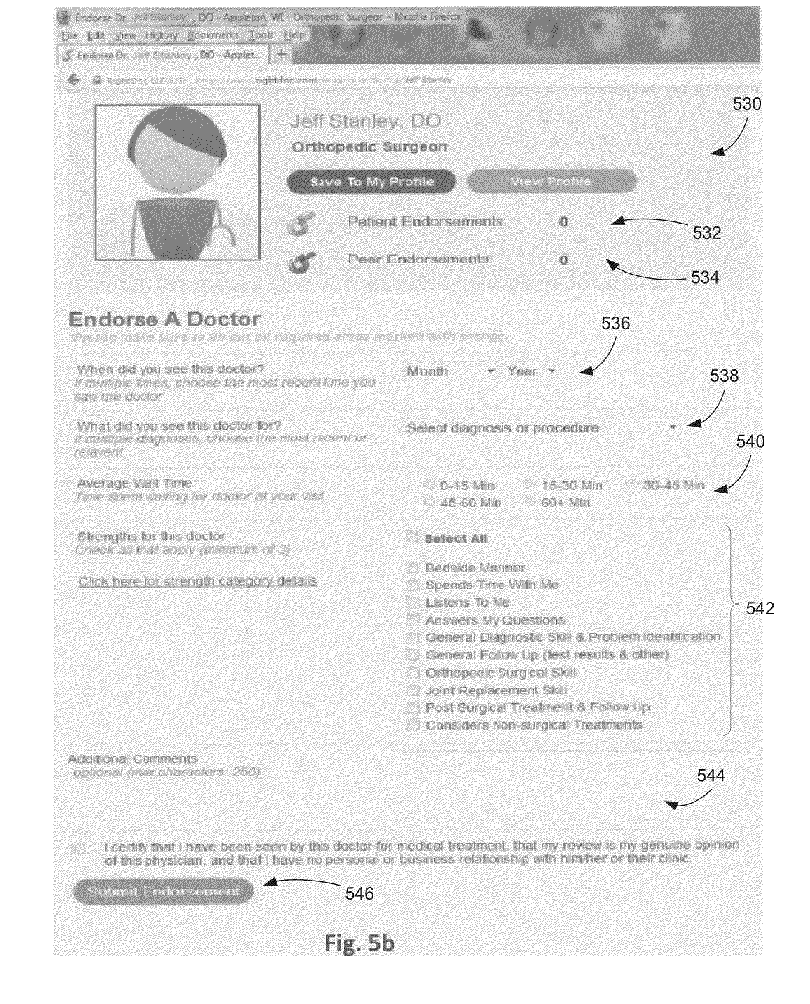

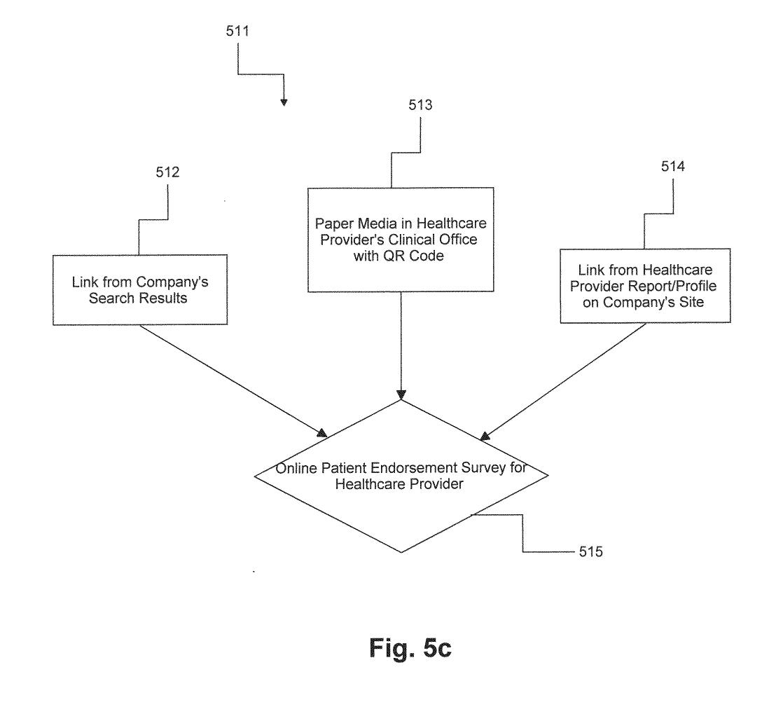

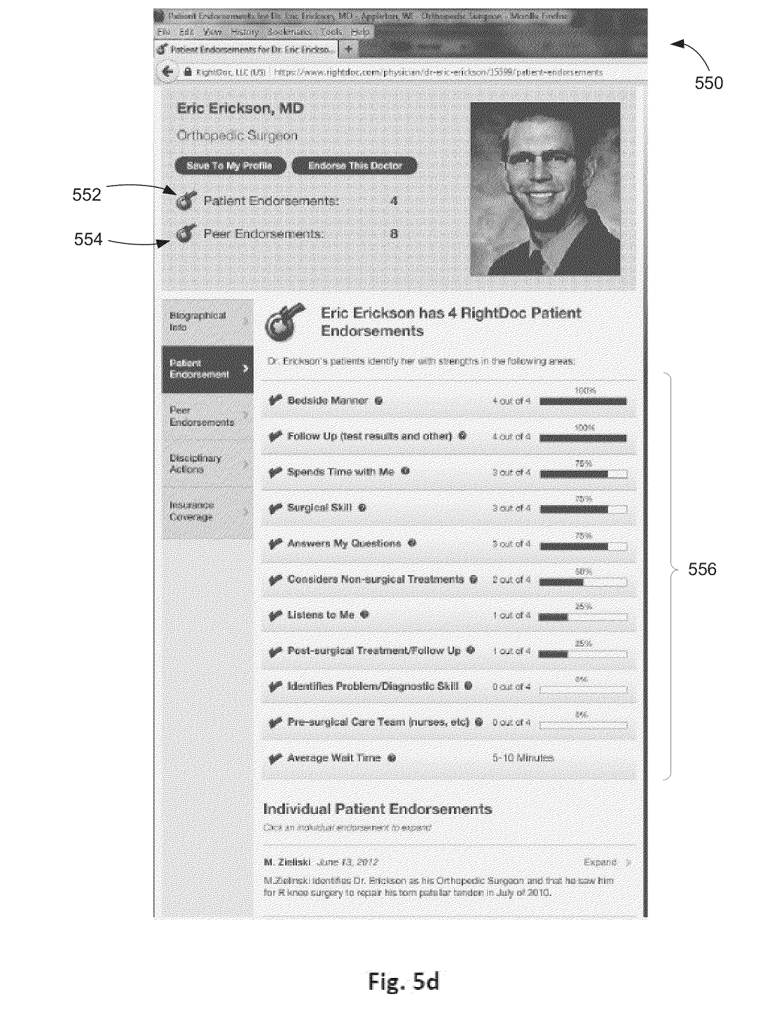

FIG. 5a provides a schematic of a web page displaying a patient endorsement survey 500 on the company website. At the top of the survey, there is information identifying the healthcare provider the survey is to be about 501 including, but not limited to, the provider's name, their specialty, and the provider's picture. Near the top of the web page the page may or may not be identified as a provider endorsement survey 502. Prior to the patient filling out an endorsement survey for a provider, the patient must be identified 503 and is identified by this patient first registering with the company website. The patient is prompted for information on the survey including when the patient last saw the provider 504, what diagnosis or procedure they saw the provider for 505 and how long they had to wait to be seen by the provider after checking in for their appointment 506.

The patient is also then asked to select particular skills that are areas of strength for the provider 507. The skills listed on a provider's survey include, but are not limited to, those skills related to their specialty or specific area of practice within their profession. The patient may choose any number of skills to identify as areas of strength for the provider. In the Figure it demonstrates a user identifying three skills, skills four, seven, and nine 508 as areas of strength for the provider.

The patient is given the option to provide comments about the provider within their endorsement 509. The user then must certify that they have in fact seen the provider that they are completing the endorsement for 510.

FIG. 5b is a representation of an example patient endorsement survey page (e.g., survey web page 530) on the company website. As shown in the example of FIG. 5b, ten skill areas (skills selection input 542) are provided for selection as endorsements from the past or current patient. A portion of the skill areas may be generic or common to all healthcare providers and another portion of the skill areas may be specific to one or more practice areas (e.g., specialties) of the respective healthcare provider. For example, six of the skills shown in skill selection input 542 of FIG. 5b may be common to all healthcare providers, regardless of the providers' specialty. However the other four skills in skill selection input 542 of the endorsement survey may be based specifically on the skills that pertain to the healthcare provider's specialty. For instance, as can be seen in skill selection input 542 of FIG. 5b demonstrating an endorsement survey for an orthopedic surgeon, six skills common to all healthcare providers are listed as (1) bedside manner, (2) follow up [test results and other], (3) spends time with me (4), answers my questions (5), listens to me, and (6) identifies problem/diagnostic skill. These six skills are the skills may be common to all healthcare provider endorsement surveys. The remaining four skills may be (7) surgical skill, (8) considers non-surgical treatments, (9) post-surgical treatment/follow up, and (10) joint replacement skill. These four skills are skills that may specifically pertain to the healthcare provider's specialty, e.g., orthopedic surgery. If the healthcare provider was a dermatologist, as another example, the skills one through six may be the same as the orthopedic surgeon; however, the remaining four skills in the endorsement survey may be specific to the specialty of dermatology and may include skills such as (7) acne management & treatment, (8) hair loss management & treatment, (9) skill performing cosmetic procedures, and (10) skin cancer prevention, management, & treatment.

Although there may be 10 skills that can be identified by former or current patients as strengths in the endorsement surveys, fewer or greater than ten skills (e.g., 6 total skills or 12 total skills) may be provided in other examples. In addition, the mixture of common skills and specialty skills may vary in other examples. For example, the number of specialty skills may be greater than the number of common skills. In other examples, the system may provide an endorsement survey that includes exclusively skills common to all providers or an endorsement survey that includes exclusively skills specific to the one or more specialties practiced by the respective healthcare provider. Furthermore, due to variations in the number of skills associated with different specialty practice areas, an endorsement survey for providers of one specialty may include fewer or greater skills than the endorsement survey for providers of a different specialty.

Former patients providing endorsements may select to learn more about the skills themselves and what it means to have strength in each of the skill areas that are listed in an endorsement survey. As can be seen in FIG. 5b to the right of the listed skills, the endorsement survey may provide a link labeled “Click Here for Strength Category Details” that may be selected by the user in order to learn details about each strength/skill category prior to selecting the strengths for a particular provider.

The skills that may be identified as strengths in the endorsement surveys (e.g., the ten skills of skill selection input 542 in the example of FIG. 5b) may be identified by the company. However, another example of an endorsement survey may include skills present in an endorsement survey that have been identified or selected by patients. For example, the patient selected skills for the endorsement survey may not have been originally included in the company created endorsement survey. Instead, one or more additional skills may be added to a specific provider's endorsement survey after a former patient suggests a skill to be included. Yet another example survey may include skills identified or selected by the respective healthcare provider himself or herself if they have chosen to customize their own endorsement survey on the company site. In this manner, skills provided in the endorsement survey may be added, deleted, replaced, or otherwise modified based on requests from one or more patients and/or the respective healthcare provider. In some examples, the website may manage any changes to skills in the endorsement survey by either confirming any patient changes and/or limiting changes to only authorized patients and/or healthcare practitioners.

Survey web page 530 may also include patient endorsement field 532 and peer endorsement field 534 that includes the number of patient and peer endorsements, respectively, already received for the identified healthcare provider. The input fields may also include date input 536 for the date of the provider visit, service input 538 for selecting the diagnosis or procedure for which the patient visited the provider, wait time input 540 for indicating the average wait time to see the provider, and comment input field 544 for receiving text input regarding the provider. Selection of confirm input 546 may submit the input provided via survey web page 530.

FIG. 5c provides a flow chart diagram 511 depicting the potential methods leading a patient to the online patient endorsement survey of a particular healthcare provider 515 on the company website. A patient may access the web page displaying the online patient endorsement survey for a healthcare provider 500 on the company website by clicking a link from healthcare provider search results on the company's website 512. The patient may also access the web page displaying the online patient endorsement survey for a provider 500 by scanning a QR code located on paper media in a healthcare provider's clinical office 513 with a mobile communications device, including but not limited to, a smart phone or tablet computer. A patient may also access the web page displaying the online patient endorsement survey for a healthcare provider 500 by clicking a link from the healthcare provider's profile or report on the company's website 514.

FIG. 5d is a representation of a portion of the healthcare provider's report or profile (e.g., report web page 550) on the company website where the healthcare provider's patient endorsement information is displayed. Note that in this particular example, the orthopedic surgeon has had a total of four patient endorsements identified within patient endorsement field 552. Peer endorsement field 554 may also include the number of endorsements from peers, such as other doctors, nurses, etc. Within the patient endorsements area of the provider's profile, the 10 possible skills users may identify as areas of strength for an orthopedic surgeon are listed (i.e., areas of strength field 556). They are listed in order of percentage, wherein the percentage represents the number of times a patient has endorsed the provider as having strength with a particular skill versus the total number of endorsements the provider has received. For instance, in the example, the surgeon has been endorsed as having a strength with bedside manner in four out of his four patient endorsements, thus 100% of the time, he is endorsed for this skill versus he is only endorsed as having a strength with considering non-surgical treatment two out of his four total endorsements, thus 50% of the time. The skills are ordered from greatest percentage to least percentage. Below this summary area of the endorsed skills is an area where individual endorsements are displayed that make up the summary information at the top. As described above with respect to FIG. 5b, the endorsements provided in the healthcare provider's report may include endorsements common to skill areas of all healthcare providers and/or endorsements specific to a specialty (e.g., orthopedic surgery) practiced by the healthcare provider.

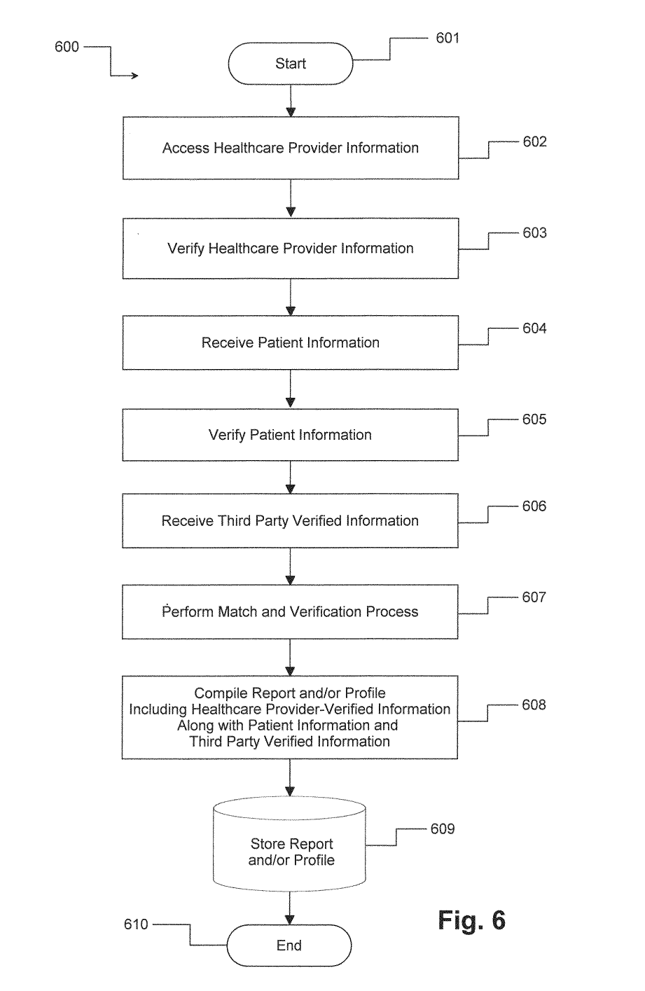

FIG. 6 provides a flow chart diagram depicting the process of how a healthcare provider's report or profile is compiled and stored in the company's database 600. The start of the process 601 begins with identification of a healthcare provider. The next step is to access healthcare provider information 602 from a variety of potential sources where the information may or may not be verified in this step. Next, the healthcare provider information may or may not be verified by the provider themselves, a third party source, or by some other individual 603. Patient provided information is then received 604 in the process from the patient endorsement survey as illustrated in FIG. 5a. A certification is required at the end of the survey 510 that requires the patient to verify that they have seen the provider they are endorsing, thus the patient provided information is verified 605. Information may or may not then be received regarding the healthcare provider that has been specifically verified by a third party 606. A match and verification process 607 is then performed which takes all of the pieces of information received and provided regarding a healthcare provider and ensures that all of the information is properly matched and verified to prepare the information for compiling.

The process then continues to the compiling, or formation, of healthcare provider profiles and/or reports 608. In an example, the compile operation 608 compiles different sources of information and data into either a profile format or report format. Other examples may involve other format types. In an example, the healthcare provider accessed information 602, patient-provided information 604, and independent third party verification information 606 is compiled into a report and/or profile 102 (FIG. 1a) and stored in database 101. In other examples, other types of information and data may be compiled into a profile. The particular examples described herein are not intended to limit the types of information which may be provided and/or verified. Next, the report or profile 102 generated in compile operation 608 is stored in database 101 in store operation 609. The process then ends 610.

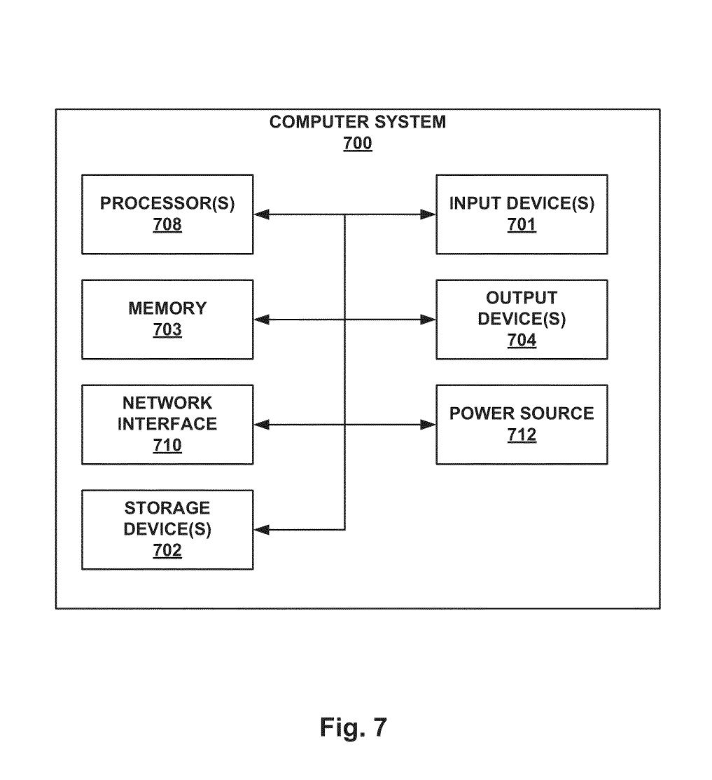

FIG. 7 provides a diagram depicting an example computer system 700 upon which the examples of the present disclosure may be implemented. Computer system 700 may be an example of web server 104 of FIG. 1a. Computer system 700 may include several components such as one or more processors 708 configured to perform one or more functions described herein. One or more processors 708 may implement functionality and/or execute instructions within computer system 700. For example, processors 708 may read and execute instructions stored by storage devices 702 that execute the functionality of software applications or modules to achieve the functionality described herein. These instructions executed by processors 708 may cause computer device 700 to store information within storage devices 702 during program execution, such as recommendations, healthcare provider reports, or any other healthcare provider related information.

Computer system 700 may include input device(s) 701 such as a mouse, keyboard, touch input device, voice input device, etc. for entering data and information. Computer system 700 may also include one or more output device(s) 704 such as a monitor, presence-sensitive display, or other display device. Computing device 700 may also include a power source 712 that provides operational power.

Computer system 700 may include one or more storage devices 702 for storing information such as the reports and/or profiles 102 described herein such as in FIG. 1. In other examples, one or more of storage devices 702 may be a repository to which computing device 700 is connected via network interface 710. Storage device(s) 702 may include, but is not limited to; removable and non-removable storage including media implemented in any method or technology for storage of information such as computer-readable instructions, data structures, program modules or other data and may include optical discs (CD-ROM and DVD-ROM), magnetics disks, and tape.

Computer system 700 may also include memory 703, which may be referred to simply as memory refers to the physical devices used to store programs (sequences of instructions) or data (e.g. program state information) on a temporary or permanent basis for use in the computer system. Memory 703, in some examples, has the primary purpose of being short term and not long-term computer-readable storage mediums. Memory 703 on computer system 700 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Memory 703 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. In other examples, the long-term storage of information may be stored in storage devices 702. Memory 703 and/or storage devices 702 may store operating system instructions, instructions for communication with other computing device, or any other information such as healthcare provider reports, recommendations, or any other information described herein.

One or more processors 708, in combination with one or more of storage unit(s) 702, input device(s) 701, output device(s) 704, and system memory 703 may be utilized by the service to provide potential patients with the ability to research healthcare providers or healthcare organizations on a company website via the Internet. For example, computing device 700 may use network interface 710 to transmit and/or receive data over one or more networks to receive patient requests and transmit information in response to the requests, such as receiving recommendations, providing healthcare provider reports, or any other functions provided herein. For example, processors 708 may be configured to obtain, via the network, verified information including, but not limited to, patient endorsements for the healthcare providers and organizations with the absence of ratings and reviews for these providers and organizations.

Transmission of information or any other data from computer system 700 may require a connection between computer system 700 and another networked device using a network. The network (e.g., network 105 of FIG. 105) may be embodied as one or more of the Internet, a wireless network, a wired network, a cellular network, or a fiber optic network. In other words, the network may be any data communication protocol or protocols that facilitate data transfer between two or more devices. Computer system 700 may also connect to a repository (e.g., database 101 or other storage device) for storing sets of data or retrieving archived data. Computer system 700 and the repository may each include one or more servers or databases, respectively. Computer system 700 may include one or more servers, desktop computers, mainframes, minicomputers, or other computing devices capable of executing computer instructions and storing data. In some examples, functions attributable to web server 104 or computer system 700 herein may be attributed to respective different servers for respective functions. The repository may include one or more memories, repositories, hard disks, or any other data storage device. In some examples, the repository may be included within computer system 700 (such as one or more of storage devices 702.

The repository may be included in, or described as, cloud storage in some examples. Computer system 700 may access the cloud and retrieve data as necessary. In some examples, the repository may include Relational Database Management System (RDBMS) software. In one example, the repository may be a relational database and accessed using a Structured Query Language (SQL) interface that is well known in the art. The repository may alternatively be stored on a separate networked computing device and accessed by computer system 700 through a network interface or system bus. The repository may in other examples be an Object Database Management System (ODBMS), Online Analytical Processing (OLAP) database or other suitable data management system.

From the description above, a number of advantages of some examples of my Internet-based system for connecting patients and healthcare providers become evident. For example, by using patient provided feedback in the form of endorsements from former patients and not allowing provider ratings, healthcare providers and the organizations that employ them will be much more open to partnering with the company providing such a system in order to facilitate the provision of patient feedback online. By using patient provided feedback in the form of endorsements from former patients that identifies specific skills that are areas of strengths for a provider will deliver users searching for healthcare providers more useful information with respect to patient provided feedback than is currently available online today. Former and/or current patients of healthcare providers may not fear or may be encouraged to provide feedback online given that there is no potential for a “rating” or negative review to be given to a provider in supplying feedback on other Internet-based system. By allowing potential patients the ability to refine and/or sort healthcare provider search result listings, especially by the skills that are identified as strengths in the patient endorsements, provides a powerful and efficient way for the patients to quickly find healthcare providers that meet their needs

Accordingly, the reader will see that the Internet-based system for connecting healthcare providers and patients, and its various examples, will be much more effective in facilitating former and/or current patients of healthcare providers to supply feedback online about their providers. This will in turn help to provide potential patients using the Internet-based system to research and find healthcare providers with a greater amount of pertinent information that will allow them to differentiate among healthcare providers and thereby select the provider that best meets their individual needs.

The disclosure also contemplates computer-readable storage media comprising instructions to cause a processor to perform any of the functions and techniques described herein. The computer-readable storage media may take the example form of any volatile, non-volatile, magnetic, optical, or electrical media, such as a RAM, ROM, NVRAM, EEPROM, or flash memory. The computer-readable storage media may be referred to as non-transitory.

The techniques described in this disclosure, including those attributed to any of web server 104, patient computer system 106, or computer system 700, and various constituent components, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in programmers, such as physician or patient programmers, stimulators, remote servers, or other devices. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Example computer-readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or any other computer readable storage devices or tangible computer readable media.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

Although the description above contains many examples, these examples should not be construed as limiting the scope of the disclosure but as merely providing illustrations of some examples in which the disclosure may be implemented. For example, any combination of the described operations or functions is contemplated. These and other examples are within the scope of the following claims.

The following features are described herein and in the Figures:
100 network environment
101 database
102 healthcare provider & organization information and data
103 local area network
104 web server
105 network
106 patient computer system
107 predetermined web search page
108 research healthcare providers search tool
109 enter the provider's location
110 enter the provider's organization
111 enter the provider's specialty
112 enter the provider's specialty
113 start the healthcare provider search button
114 research healthcare organizations search tool
115 enter the organization's location
116 enter the organization's name
117 enter the organization's type
118 start the healthcare organization search button
119 links to alphabetized provider lists
120 links to alphabetized organization lists
130 search web page
132 location search criteria
134 specialty search criteria
136 name search criteria
200 provider & organization research process
201 start searching for providers or organizations
202 decide what to research
203 decide what criteria to search providers by
204 decide what criteria to search organizations by
205 combination of provider location and name
206 combination of provider location and specialty
207 combination of provider location and organization
208 combination of organization location and name
209 combination of organization location and type
210 combination of organization location and type
211 healthcare providers search results
212 healthcare organizations search results
213 healthcare provider search results page
214 search criteria used to receive results
215 refine results tool
216 sort results tool
217 skills example of sort criteria
218 list of healthcare providers in search results
219 advertisement for PRO member provider
220 process of refining and/or sorting results
221 healthcare providers search results list
222 decide to sort or refine results list
223 select to use options to refine
224 refine by insurance plan accepted
225 refine by only providers with endorsements
226 refine by the provider's gender
227 select to use options to sort
228 sort by distance from location
229 sort by patient endorsed skills
230 sort by provider's years of experience
231 web page with sorted and/or refined provider results
232 endorsements only refinement
233 sorting by patient endorsed skills
234 specific skill selected for sorting
235 providers in results list remaining after sort/refine
236 endorsed skill listing for provider
237 endorsed skill listing for another provider
240 results web page
242 results list
244 view profile input
246 request to endorse input
248 refine results tool
250 sort results tool
260 results web page
262 results list
264 view profile input
266 request to endorse input
268 refine results tool
270 sort results tool
300 web page displaying provider profile or report
301 title of provider profile or report
302 healthcare provider name
303 provider picture
304 provider verified information in profile or report
305 company verified information in profile or report
306 patient provided information in profile or report
307 provider contact information
308 provider's years of experience
309 provider's specialty information
310 provider's medical school information
311 provider's clinical interests
312 provider's hospital affiliation(s)
313 provider's advanced training
314 provider's languages spoken
315 provider's articles and publications
316 provider's procedures performed
317 provider's clinic details
318 provider's cost of services
319 provider's awards and honors
320 provider's professional memberships
321 provider's board certification(s)
322 provider's disciplinary action(s)
323 provider's patient endorsements
324 provider's skills endorsed by former patients
325 provider's practice location
326 provider's hours of operation
330 healthcare provider report
332 provider verified information
334 patient endorsement field
336 peer endorsement field
400 process leading user from internet search engine to site
401 potential patients using internet
402 access Internet search engine
403 enter search data on search engine
404 receive search engine results including link to site
405 user clicks link leading to company site
406 leads to a healthcare provider profile or report
407 leads to a search results list on the company site
500 web page displaying patient endorsement survey
501 healthcare provider endorsement is for
502 title of patient endorsement survey
503 former patient is identified
504 when patient last saw provider is identified
505 what patient saw provider for is identified
506 wait time for provider is identified
507 select skills that are strengths for provider
508 example of skills selected as strengths by the patient
509 optional comments about provider
510 certification
511 methods leading patient to endorsement survey
512 link to survey from company's search results
513 paper media in provider's office with QR code
514 link to survey from provider profile or report
515 the online patient endorsement survey
530 survey web page
532 patient endorsement field
534 peer endorsement field
536 date input
538 service input
540 wait time input
542 skills selection input
544 comment input field
546 confirm input
550 report web page
552 patient endorsement field
554 peer endorsement field
556 areas of strength field
600 process for provider profiles or reports to be compiled
601 start of process identifying a provider
602 access healthcare provider information
603 verify healthcare provider information
604 receive patient information
605 verify patient information
606 receive third party verified information
607 perform match and verification process
608 compile profile and/or report
609 store profile and/or report
610 end of compile process
700 system with examples of the disclosure
701 input device(s)
702 storage
703 system memory
704 output device(s)

What is claimed is:

1. A method comprising:
receiving, by a first computing device associated with a service for connecting healthcare providers with potential patients, a request for information regarding healthcare providers, wherein the first computing device comprises at least one processor;
accessing, by the first computing device, healthcare provider-verified information about a plurality of healthcare providers, wherein the healthcare provider-verified information is received from the healthcare providers;
compiling, by the at least one processor, patient provided information related to one or more of the plurality of healthcare providers, wherein the patient provided information comprises patient endorsements from one or more past or current patients of the healthcare providers, and wherein the patient endorsements were received via an online patient endorsement survey configured to receive a positive indication of strength for each of a plurality of skill areas associated with each of the healthcare providers, and wherein the online patient endorsement survey is hosted by a website associated with the service for connecting healthcare providers with the potential patients;
compiling information regarding the healthcare providers verified by an independent third-party source;
generating, by the at least one processor and based on the healthcare provider-verified information, the patient provided information, and the information regarding the health care providers verified by the independent third-party source, a healthcare provider report for at least one of the plurality of healthcare providers, wherein the healthcare provider report for the at least one healthcare provider is configured to include one or more endorsements of the at least one healthcare provider, and wherein the one or more endorsements relate to respective skill areas of the at least one health care provider; and
transmitting, by the at least one processor and via a network, the healthcare provider report to a second computing device.

2. The method of claim 1, wherein each of the patient endorsements comprise an identification of one or more skill areas of strength, each of the one or more skill areas of strength associated with a respective specific specialty practice area of the respective healthcare provider.

3. The method of claim 1, wherein the plurality of healthcare providers comprise at least one of physicians, chiropractors, or dentists.

4. The method of claim 1, wherein the plurality of healthcare providers comprise healthcare organizations.

5. The method of claim 1, further comprising obtaining the patient provided information, wherein obtaining the patient provided information comprises:
providing, to the one or more past or current patient of the healthcare providers and via the network, access to a report for one of the healthcare providers;
receiving, from the one or more past or current patients, one or more selections that complete the online patient endorsement survey; and
collecting, via the online patient endorsement survey, data related to the one of the healthcare providers.

6. The method of claim 1, further comprising obtaining the patient provided information, wherein obtaining the patient provided information comprises:
providing, to the one or more past or current patient of the healthcare providers and via the network, access to a report for one of the healthcare providers, wherein access is provided in response to scanning, with a mobile computing device, of a QR code located on paper media provided in an office of one of the plurality of healthcare providers;
receiving, from the one or more past or current patients using the mobile computing device, one or more selections that complete the online patient endorsement survey; and
collecting, via the online patient endorsement survey, data related to the one of the healthcare providers.

7. The method of claim 1, further comprising outputting a predetermined web page configured to provide access to the healthcare provider report and provide search capabilities for a database comprised of healthcare provider information.

8. The method of claim 7, wherein the search capabilities permit a search based search criteria comprising one or more of a name of the healthcare provider, a medical specialty, a gender of the healthcare provider, a state, a city, a procedure, a diagnosis, and a location.

9. The method of claim 8, further comprising:
receiving a selection of one of more of the search criteria;
searching, by the at least one processor and based on the selected search criteria, the database; and
producing, by the at least one processor and based on the search, a results list of one or more of the plurality of healthcare providers satisfying the selected search criteria.

10. The method of claim 9, further comprising sorting the list of one or more healthcare providers by sorting criteria, wherein the sorting criteria comprises at least one of, a distance from the location, years of experience, or endorsement related information.

11. The method of claim 9, further comprising refining the list of one or more healthcare providers based on refining criteria, wherein the refining criteria comprises at least one of the gender of the healthcare provider, insurance plans accepted, healthcare providers with enhanced reports, and healthcare providers having one or more endorsements.

12. The method of claim 9, further comprising at least one of sorting the list or refining the list based on one or more skill areas identified as skill areas of strength for the healthcare providers within each respective endorsements of the healthcare providers supplied by one or more past or current patients.

13. The method of claim 9, wherein the results list further comprises an advertisement for one of the plurality of healthcare providers, and wherein the advertisement comprises a hyperlink to information on the report of the one of the plurality of healthcare provider.

14. The method of claim 9, further comprising positioning healthcare providers associated with a respective enhanced report receive higher in the results list than healthcare providers not associated with the respective enhanced report.

15. The method of claim 1, wherein at least one of the one or more endorsements of the at least one healthcare provider included within the healthcare provider report is an endorsement associated with a skill area common to all of the plurality of healthcare providers.

16. The method of claim 1, wherein at least one of the one or more endorsements of the at least one healthcare provider included within the healthcare provider report is an endorsement associated with a skill area specific to a specialty practiced by at least one of the plurality of healthcare providers.

17. A system for connecting healthcare providers with potential patients, the system comprising:
at least one processor configured to:
receive a request for information regarding a healthcare provider;
access healthcare provider-verified information about the healthcare provider, wherein the healthcare provider-verified information is received from the healthcare provider;
compile patient-provided information related to the healthcare provider, wherein the patient provided information comprises patient endorsements from one or more past or current patients of the healthcare provider, and wherein the patient endorsements were received via an online patient endorsement survey configured to receive a positive indication of strength for each of a plurality of skill areas associated with the healthcare provider, and wherein the online patient endorsement survey is hosted by a website associated with a service for connecting healthcare providers with the potential patients and completed by the one or more past or current patients of the healthcare provider;
compile healthcare provider information regarding the healthcare provider verified by an independent third-party source;
generate, based on the healthcare provider-verified information, the patient-provided information, and the information verified by the independent third-party source, a healthcare provider report for the healthcare provider, wherein the healthcare provider report for the healthcare provider is configured to include one or more endorsements of the healthcare provider; and
transmit, via a network, the healthcare provider report to a patient computing device.

18. The system of claim 17, wherein:
the healthcare provider report is obtained through one or more from the group consisting of: a predetermined web page that provides search capabilities of an associated database and a third-party search engine; and
the search capabilities of the predetermined web page permit searching based on search criteria comprising one or more of a name of the healthcare provider, a medical specialty, a gender of the healthcare provider, a state, a city, a procedure, a diagnosis, and a location.

19. The system of claim 18, wherein the at least one processor is configured to receive one or more search criteria and produce a results list of one or more healthcare providers satisfying the received search criteria.

20. The system of claim 19, wherein the at least one processor is configured to sort, based on sorting criteria, the list of one or more healthcare providers, and wherein the sorting criteria comprises at least one of a distance from the location, years of experience, and endorsement related information.

21. The system of claim 19, wherein the at least one processor is configured to refine, based on refining criteria, the list of one or more healthcare providers, and wherein the refining criteria comprises at least one of a gender of the healthcare provider, insurance plans accepted, healthcare providers with enhanced reports, and healthcare providers having one or more endorsements.

22. The system of claim 19, wherein the at least one processor is configured to at least one of sort the list or refine the list based on one or more skill areas identified as skill areas of strength for the healthcare provider within the endorsements of the healthcare provider supplied by one or more past or current patients.

23. A computer-readable storage medium comprising instructions that, when executed by one or more processors of a first computing device, cause the one or more processors to:
receive, by the first computing device associated with a service for connecting healthcare providers with potential patients, a request for information regarding healthcare providers, wherein the first computing device comprises at least one processor;
access, by the first computing device, healthcare provider-verified information about a plurality of healthcare providers, wherein the healthcare provider-verified information is received from the healthcare providers;
compile patient provided information related to one or more of the plurality of healthcare providers, wherein the patient provided information comprises patient endorsements from one or more past or current patients of the healthcare providers, and wherein the patient endorsements were received via an online patient endorsement survey configured to receive a positive indication of strength for each of a plurality of skill areas associated with each of the healthcare providers, and wherein the online patient endorsement survey is hosted by a website associated with the service for connecting healthcare providers with the potential patients;
compile information regarding the healthcare providers verified by an independent third-party source;
generate, based on the healthcare provider-verified information, the patient provided information, and the information regarding the health care providers verified by the independent third-party source, a healthcare provider report for at least one of the plurality of healthcare providers, wherein the healthcare provider report for the at least one healthcare provider is configured to include one or more endorsements of the at least one healthcare provider, and wherein the one or more endorsements relate to respective skill areas of the at least one health care provider; and
transmit, via a network, the healthcare provider report to a second computing device.
